(19) United States
(12) Patent Application Publication
(10) Pub. No.: US 2010/0109359 A1
(43) Pub. Date: May 6, 2010

(54) APPARATUS AND METHOD FOR THE ENGAGEMENT OF INTERMODAL UNITS

(75) Inventors: Robert Arthur Mills, Lancashire (GB); Ghee Hua Ng, Singapore (SG); ZhanMin Tong, Singapore (SG)

Correspondence Address: SNELL & WILMER L.L.P. (Main), 400 EAST VAN BUREN, ONE ARIZONA CENTER, PHOENIX, AZ, 85004-2202, US

(73) Assignee: NSL ENGINEERING PTE LTD, Singapore (SG)

(21) Appl. No.: 12/598,497

(22) PCT Filed: Apr. 30, 2008
(86) PCT No.: PCT/SG08/00149

§ 371 Date: Nov. 2, 2009

(30) Foreign Application Priority Data
May 3, 2007 (SG) 200703048-9

(51) Int. Cl. B66C 1/10; B66C 1/42

(52) U.S. Cl. 294/81.2

(57) ABSTRACT

An engagement device (5) comprising a hub (15); a plurality of discrete projection members (20A-20D) mounted to said hub (15) at a respective first ends of said members, said members selectively extendable from said hub (15); a sheave and engagement apparatus (25A-25D) mounted to each projection member (20A-20D), the engagement apparatus for engaging at least one intermodul unit; wherein extension of the projection members (20A-20D) moves the respective sheave and engagement apparatus (25A-25 D) relative to said hub (15).

### FIELD OF INVENTION

The invention relates to the manipulation of intermodal units such as containers, flat racks and other devices used for containing freight for shipping. It further relates to intermediate units such as spreaders. In particular, the invention relates to devices and methods for engaging the intermodal units including engaging multiple containers at one time and shifting their relative positions.

### BACKGROUND OF THE INVENTION

It is well established that a key economic factor involved in the shipping of containers is the speed by which containers are loaded, unloaded and moved around a container yard. Recently inventions relating to the engagement and movement of more than one container have been suggested. One such system is that disclosed in WO 01/98195, the contents of which are incorporated herein by reference. Here, two containers are engaged at one time and, therefore, can be moved in the same time that a conventional spreader would engage a single container. However, in placement of the containers, the relative position of the containers at the point of being engaged may not fit with that of the point of disengagement. For instance, loading two containers from a wharf, being a flat rigid surface, may be done with relative ease. However, moving these containers to a ship that may be subject to wave and wind action, may not provide the same flat surface and so making the task more difficult. Consequently, the invention of WO 01/98195 may not provide a real dual carriage benefit as it is not able to place the containers as easily as it was able to engage them.

Another system is disclosed in WO 03/104132, the contents of which are incorporated herein by reference. This reference discloses another system capable of lifting two or more simultaneously. Here a scissor lifter shown in FIG. 1 of the document provides for a range of relative positions which may be used in order to vary the relative positions of the containers from the position that which they are engaged to the position which they are disengaged. However, the device 10 shown in FIG. 1 is a large, cumbersome device involving significant weight and cost of manufacture.

It would, therefore, be advantageous if a device for engaging multiple containers could achieve the same result of engaging and moving these containers without the considerable infrastructure involve.

### SUMMARY OF INVENTION

It is therefore, an object of the invention to provide a method and device for moving two or more containers simultaneously and shifting the relative position of the containers whilst under engagement and further still, that the construction of this device be of lighter construction than that of the prior art.

In the first aspect the invention provides an engagement device comprising a hub; a plurality of discreet projection members mounted to said hub at a respective first ends of said members, said members selectively extendable from said hub; a sheave and engagement apparatus mounted to each projection member, the engagement apparatus for engaging at least one intermodal unit; wherein extension of the projection members moves the respective sheave and engagement apparatus relative to said hub.

In a second aspect, the invention provides a method for extending an engagement device comprising the steps of: extending a first actuator mounted between a hub and a rotational member said rotational member and hub connected through a first pivotal joint; and so rotating the rotational member about the first pivotal joint from a vertical position to a horizontal position.

Thus, the invention provides a central support, being the hub and discreet “arms” projecting outward from the hub in order to engage the spreaders, containers or other intermodal units. By comparison the device of WO 03/104132 includes two substantial head frames for engaging the spreaders, which are connected through a scissor lift, and so does not provide for a central hub.

In a preferred embodiment, the movement of the projection members may be such that, on engagement with more than one intermodal unit, the units may be moved relative to each by extended and retracting the projection members.

Further, by having individual discreet members, it is possible to extend or retract some projection members without affecting others. Accordingly, in addition to moving the relative position of the containers in the transverse direction, it may be possible to shift the relative position of the containers in other dimensions including relative rotation about the vertical axis, by extending (or retracting) one projection member only.

In a preferred embodiment, the device may have at least two fundamental configurations, being a retracted position whereby the device is narrow enough to engage a single spreader, and a first extended position whereby it may engage two spreaders in close proximity.

In a further preferred embodiment, the device may further extend so as to separate the spreaders, and consequently containers whilst engaged with said device.

The invention is characterized by including near or at the end of each projection member means to engage cables for lifting and lowering the device, and further means to engage intermodal units. In a preferred embodiment, both these features may be included as an integral element, such as a block. The cable engaging element may therefore be a sheave, and the intermodal unit engaging element may be a single or multiple twist lock engaging device.

In a preferred embodiment, the projection members may be telescopically extendable portion. Alternatively, they may include portions that swing or unfold within the horizontal plane.

In a preferred embodiment, the hub may be smaller than a 20 foot or 40 foot container. Accordingly, the projection members may project outwards from the hub in a star type formation. Alternatively, the hub may be similar in size, and so the projection members projecting laterally outward, perpendicular to a longitudinal axis of the hub.

In a still further embodiment, each projection member may include a rotational member pivotally mounted to the hub at a first pivotal joint and a sleeve member in sliding engagement with the rotational member, said sleeve member pivotally mounted at a second pivotal joint to the block.

### BRIEF DESCRIPTION OF DRAWINGS

It will be convenient to further describe the present invention with respect to the accompanying drawings that illustrate possible arrangements of the invention. Other arrangements of the invention are possible and consequently the particularity of the accompanying drawings is not to be understood as superseding the generality of the preceding description of the invention.

FIG. 1 is an isometric view of the engagement device in a retracted position according to one embodiment of the present invention;

FIG. 2 is an isometric view of the engagement device of FIG. 1 in a first extended position;

FIG. 3 is an isometric view of the engagement device of FIG. 1 in a second extended position;

FIG. 4A is a detail isometric view of the engagement device in the retracted position;

FIG. 4B is an elevation view of the engagement device of FIG. 4A;

FIG. 5A is an isometric detail view of the engagement device in a first extended position;

FIG. 5B is an elevation view of the engagement device of FIG. 5A;

FIG. 6A is a detail isometric view of the engagement device in a second extended position;

FIG. 6B is an elevation view of the engagement device of FIG. 6A.

### DESCRIPTION OF PREFERRED EMBODIMENT

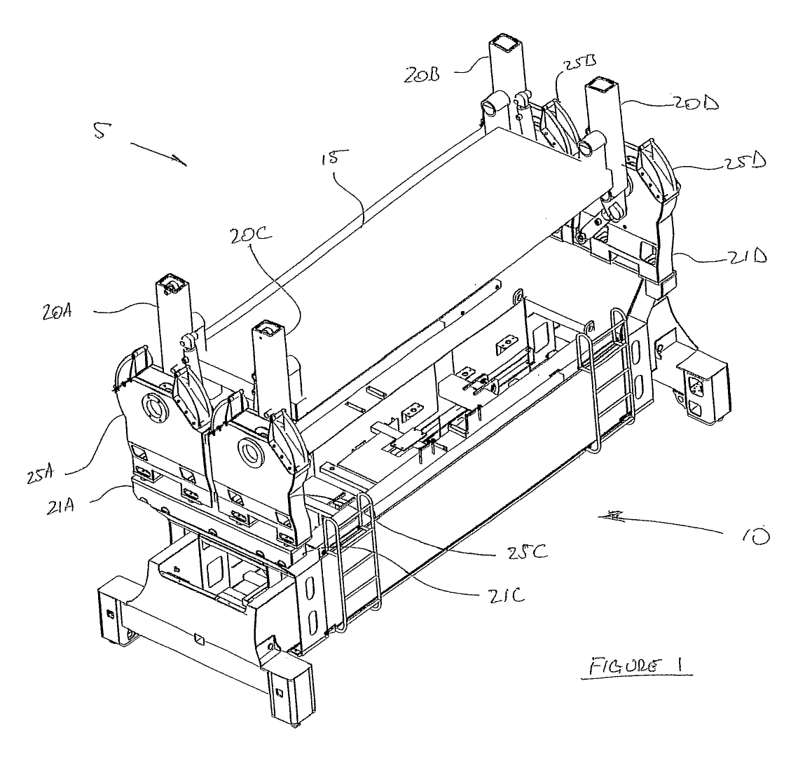

FIGS. 1 to 3 show the engagement device 5 according to one embodiment in various stages of operation. In particular, FIG. 1 shows the engagement device 5 in a fully retracted position whilst in engagement with a spreader 10. The engagement device 5 comprises a central hub 15 to which is mounted projection members 20A to 20D which lie intermediate the central hub 15 and sheaves 25A to 25D, with one of said sheaves mounted at an end of each projection member 20A to 20D.

In this orientation the projection members 20A to D are retracted such that the sheaves 25A to 25D have come into contact with each other. Further the projection members 20A to 20D include container engagement portions 21A to 21D. In this embodiment the sheaves and engagement portions 21A to 21D are arranged as a block mounted to the under portion of the sheaves 25A to 25D. Thus in the retracted position as shown in FIG. 1, as the sheaves come into close proximity, the engagement portions 21A to 21D also come into a retracted portion. In this embodiment the device has retracted to a width which is sufficient to engage a single spreader 10.

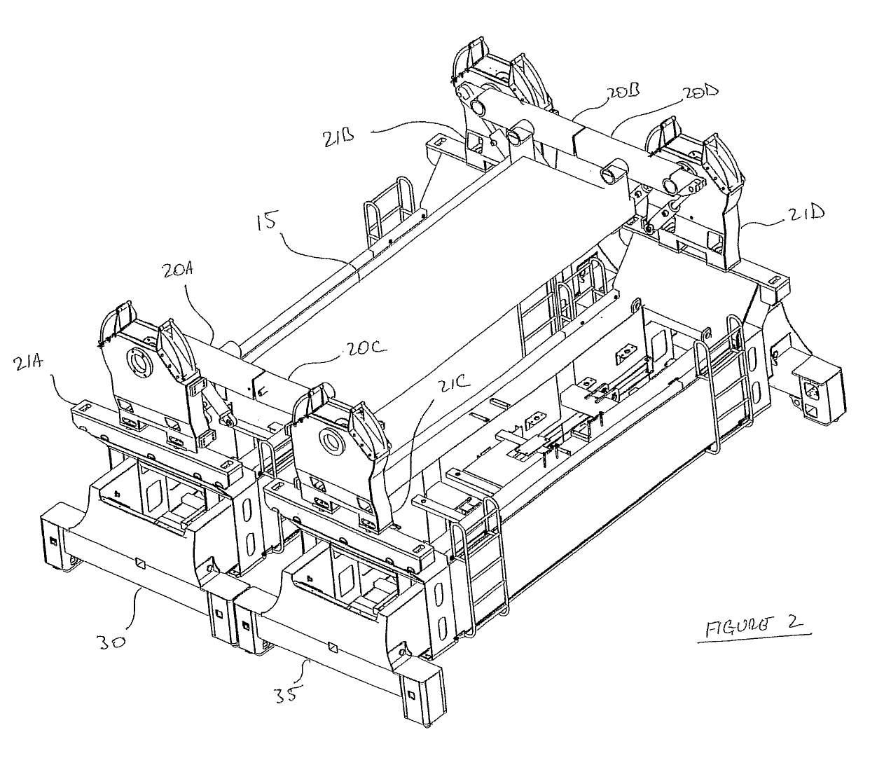

FIG. 2 shows the same engagement device 5 in a first extended position. Here the projection members 20A to 20D have extended out from the hub 15 and so projecting the sheaves 25A to 25D away from said hub 15. In this position representing a first extended position, the engagement portions 21A to 21D are sufficiently separated so as to engage two spreaders 30, 35 in a side by side orientation. The spreaders 30, 35 are in close proximity whilst the engagement device 5 is in this orientation.

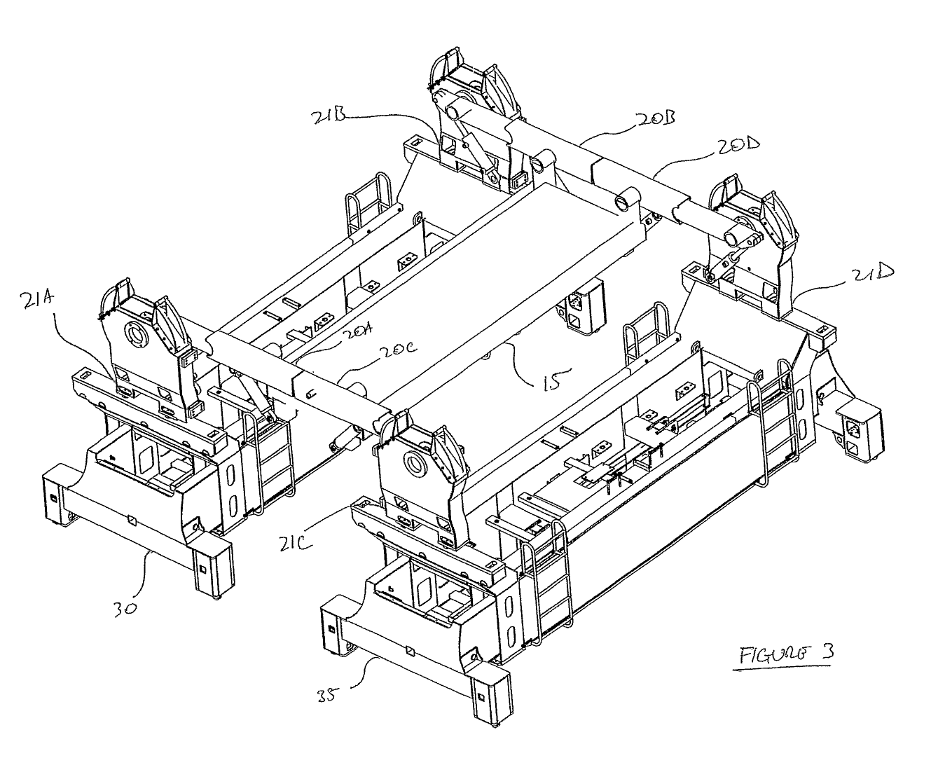

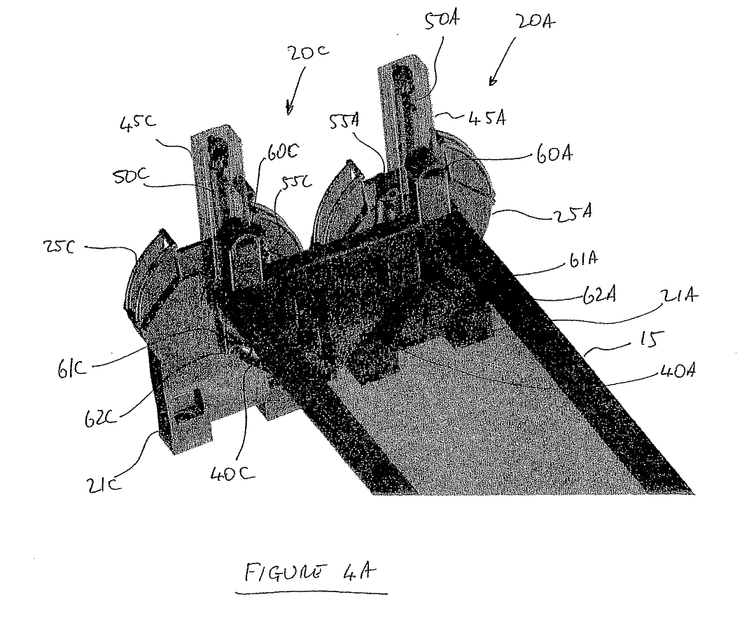

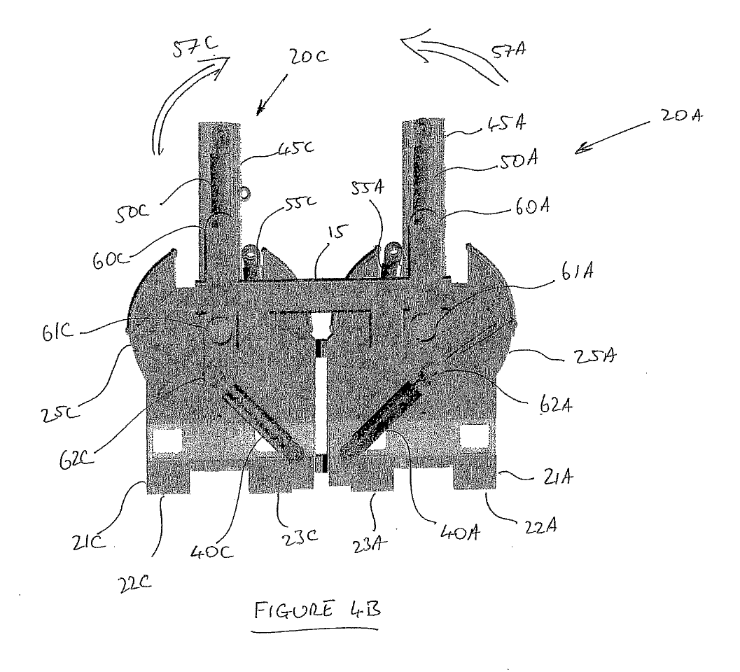

FIG. 3 shows a further configuration of the device 5 whereby the projection members 20A to 20D have further projected away from the hub 15, whilst the engagement portions 21A to 21D are still engaged with the spreaders 30, 35. However, in this second expanded configuration, the spreaders 30, 35 are further separated from each other and have the effect of separating containers which may be mounted to said spreaders 30, 35 through extension of the projecting members 20A, 20D outwards from the central hub 15. FIGS. 4 to 6 will more clearly describe the manner in which the projection members 20A to 20D function so as to project outwards from the central hub 15.

FIGS. 4A and 4B show a detailed view of one end of the central hub 15 focusing on projection members 20A, 20C located at that end. It should be noted that the projection members 20B, 20D function in precisely the same way. It should be noted further still that in a further embodiment the projection members 20B, 20D may not necessarily move at the same time, rate or extension as each other or as those of 20A, 20C. Accordingly having varying rates and lengths of extension of said projection members 20A to 20D may lead to relative re-orientation of spreaders mounted to said engagement portions 21A to 21D and so shift the orientation of said spreaders and consequently of any containers mounted thereto.

FIGS. 4A and 4B show the engagement device according to one embodiment of the present invention whereby in this configuration, the sheaves are retracted so as to bring them into close proximity if not in actual contact. In this orientation the engagement portions 21A, 21C are such that the width of said device is sufficient to mount to a single spreader for engagement with a single container. Thus in this retracted position as shown in FIGS. 4A and 4B, the engagement device functions similar to a single head block ready for mounting to a spreader for a single container.

In detail, the engagement device 5 comprises the central hub 15 to which are mounted projection members 20A, 20C. Each projection member 20A, 20C comprises a rotational member 45A, 45C pivotally mounted to the central hub 15.

The rotational members 45A, 45C are accordingly pivotally mounted to the central hub 15 through pivotal joint 60A, 60C about which the rotational member 45A, 45C may rotate. The rotational members 45A, 45C are further mounted to the sheaves at a pivotal joint 61A, 61C. In this fully retracted position, the rotational members 45A, 45C are directed upwards so as to fold out of the way of the sheaves retracting inwards. In this embodiment, the rotational members 45A, 45C being vertical permit the alignment of the pivotal member and rotational member 60A, C, 61A, C along a vertical axis. Accordingly the engagement members 21A, 21C which define a “width” of the device 5, are brought into closer proximity and accordingly the “width” between the external portions of the engagement members 21A, 21C is equal to a conventional width of a spreader. It follows, therefore, that in the retracted position, the device 5 acts as a single head block for engaging a single spreader through engagement members 21A, 21C.

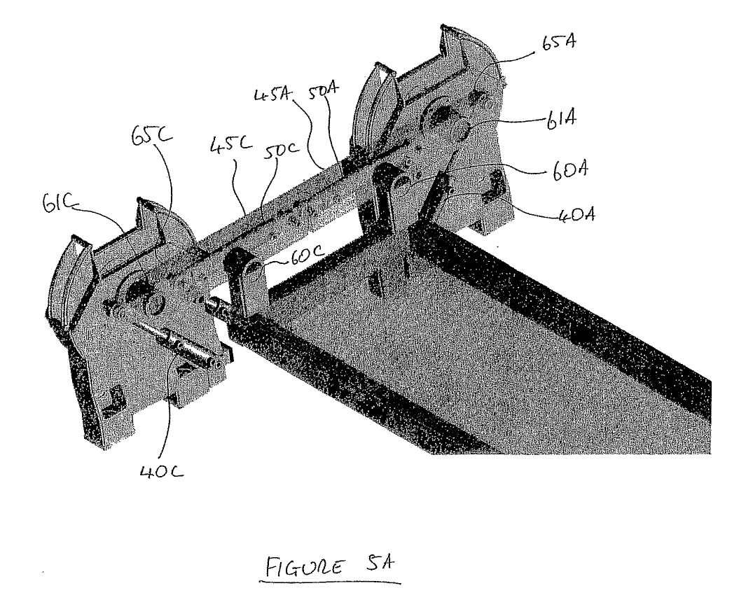

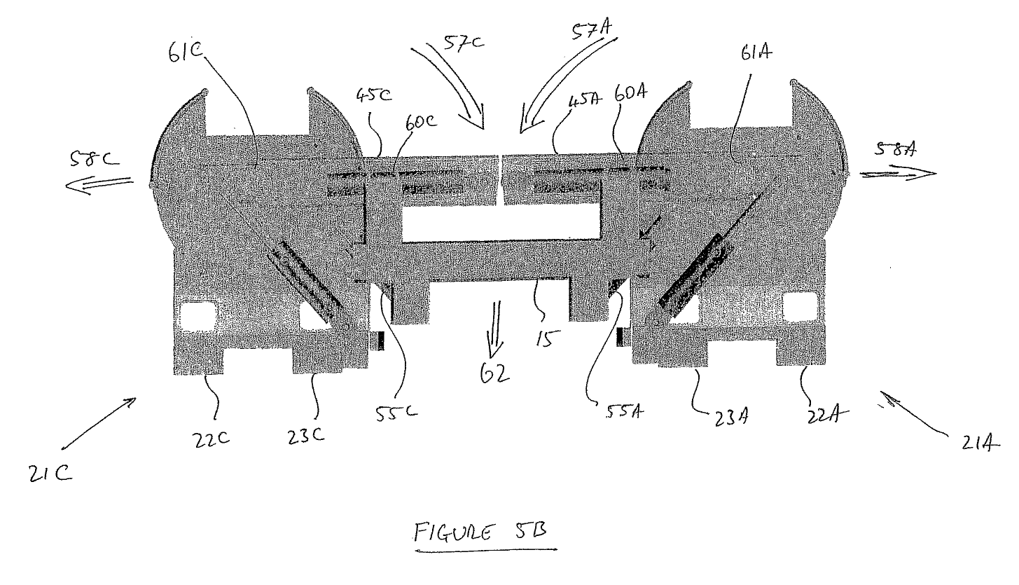

Turning to the projection members 20A, 20C, each of said members include the aforementioned rotational member 45A, 45C. Within each rotational member is sleeved a further member 65A, 65C as shown in FIGS. 5A and 5B. This sleeved member includes the connection of the sheaves to the projection members through the pivotal members 61A, 61C. It is further connected to the rotational member through an actuator 50A, 50C located within the projection member 20A, 20C and aligned along an axis of the projection member. At an opposed end of the sleeved member 65A, 65C is a further actuator 40A, 40C which connects the sleeved member to the sheaves at a portion adjacent to the engagement member 21A, 21C.

In this retracted position as shown in FIGS. 4A and 4B, the device 5 extends out through operation of the various actuators associated with the projection members. In particular, the extension process involves actuators 55A, 55C which are mounted between the hub 15 and the rotational members 45A, 45C. The extension process commences with these actuator 55A, 55C extending and so applying a force to the projection member 20A, 20C so as to cause a rotation 57A, 57C of the rotational members 45A, 45C about the pivotal joints 60A, 60C.

FIGS. 5A and 5B show the result of activation of the first hydraulic ram 55A, 55C. In particular it shows the full extension of the actuators 55A, 55C and the result in the full rotation 57A, 57C of the projection member. Here the projection member 20A, 20C is now horizontal, resulting in the extension of the sheaves 25A, 25C outwards from the central hub 15. Because of the twin rotational joints 60A, C, 61A, C, rotation of the extension members 20A, 20C results in a lowering 62 of the central hub so as to bring the rotational and pivotal joints into the same horizontal plane. This permits subsequent extension of the sheaves outward from the central hub 15 on activation of the various actuators.

In this first extended position as shown in FIGS. 5A and 5B, the engagement portions 21A, C are now separated so as to provide sufficient clearance to engage two spreaders and subsequently two containers in close proximity. Thus the position shown in FIGS. 5A and 5B is the first position for which the device 5 may be used to engage two separate spreaders. This is in contrast to the retracted position, as shown in FIG. 4B, whereby the device is of such a width that the portions 22A, 23A, 22C, 23C of engagement members 21A and 21C are used to engage a single spreader. In this first extended position, as shown in FIG. 5B, each spreader will connect to the two engagement portions of each engagement member, that is, the portions are divided with one set 22A, 23A used for one spreader and the second set 22C, 23C used for the second.

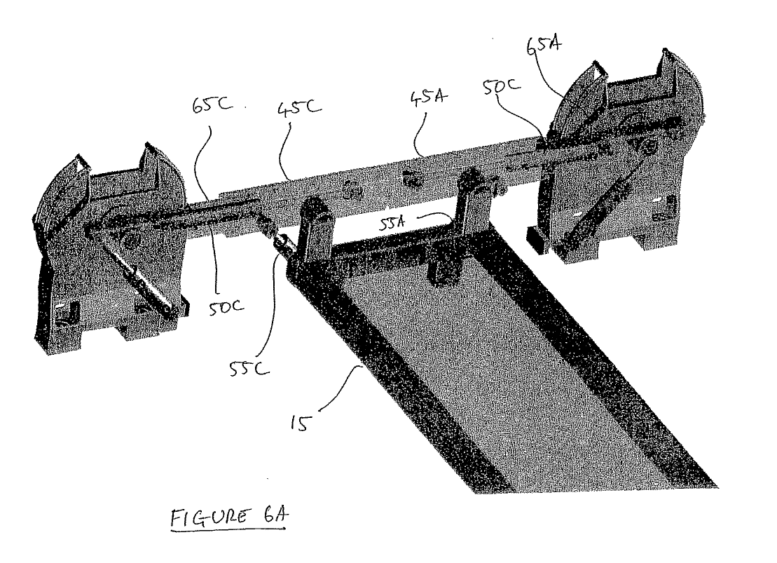

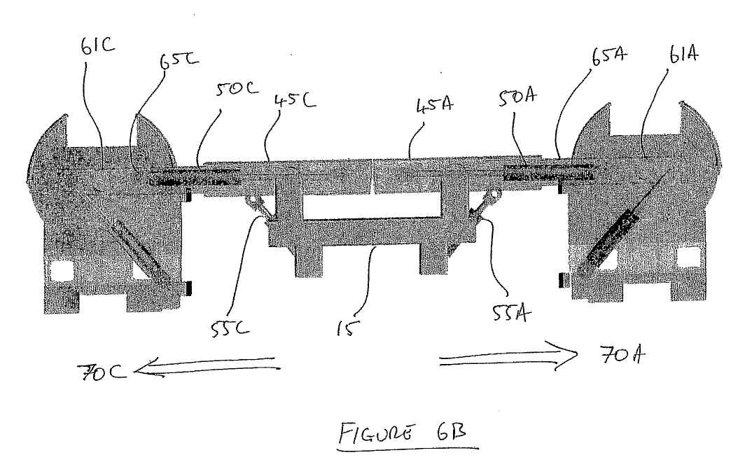

FIGS. 6A and 6B show the result of extension of the second actuator 50A, 50C within the projection members 20A, 20C. As will be seen in the figures, the sheaves are further extended 70A, 70C outward from the hub 15 resulting in further extension of the spreaders and containers attached thereto (not shown), resulting from this further extension.

Additional actuators 40A, 40C are mounted between the sleeve members 65A, 65C and sheave 25A, 25C. These additional actuators 40A, 40C serve as damping cylinders as well as keeping the sheaves 25A, 25C level with the ground. As rotational member 45A, 45C rotates from retracted to the first extended position. The additional actuators change in length and to rotate the sheaves about the pivotal joint 61A, 61C to maintain the sheaves level with the ground. The variation of the actuator length is achieved either by a hydraulic damping circuit or active cylinder position control.

1. An engagement device comprising
a hub;
a plurality of discreet projection members, each mounted to said hub at respective first ends of said members, said members selectively extendable from said hub;
a sheave and engagement apparatus mounted to each projection member, the engagement apparatus for engaging at least one intermodal unit;
wherein extension of the projection members moves the respective sheave and engagement apparatus relative to said hub.

2. The device according to claim 1, wherein the intermodal units include shipping containers, flat racks or spreaders.

3. The device according to claim 1, wherein the projection members are adapted to extend or retract laterally from the hub.

4. The device according to claim 1, wherein the device is reconfigurable from a retracted position whereby the projection members are fully retracted to a first extended position whereby the projection members are partially extended.

5. The device according to claim 4, wherein the retracted position is defined as the engagement apparatus of each projection member being spaced so as to collectively engage a single intermodal unit.

6. The device according to claim 4, where the first extended position is defined as the engagement apparatus of each projection member being arranged into a first and second array, the engagement apparatus of each array mutually positioned such that the first array engages a first intermodal unit and the second array engages a second intermodal unit.

7. The device according to claim 1, wherein the sheave and engagement apparatus are mounted adjacent to a second end of the respective projection members.

8. The device according to claim 1, wherein the sheave and engagement apparatus are integrally connected to form a block, said block positioned adjacent to the respective second end of said member.

9. The device according to claim 8, wherein each projection member comprises a rotational member pivotally mounted to the hub at a first pivotal joint and a sleeve member in sliding engagement with the rotational member, said sleeve member pivotally mounted at a second pivotal joint to the block.

10. The device according to claim 9, further including a first actuator mounted between the rotational member and the hub.

11. The device according to claim 10, wherein the first actuator is arranged such that on activation the first actuator biases the rotational member leading to rotation of the rotational member about the first pivotal joint and consequently the device reconfiguring from the retracted position to the first extension position.

12. The device according to claim 4, wherein in the retracted position the projection member is vertical and in the first extension position the projection member is horizontal.

13. The device according to claim 4, wherein the device is reconfigurable from the first extended position to a second extended position whereby the projection members are fully extended so as to separate the two intermodal units.

14. The device according to claim 13, wherein each of the projecting members include a second actuator mounted between the rotational member and the sleeve member such that on activation the second actuator extends the sleeve member relative to the rotational member so as to effect the reconfiguration from the first extended position to the second extended position.

15. The device according to claim 14, wherein the second actuator is adapted to be progressively extendable between the first and second extended positions.

16. A method for extending an engagement device comprising the steps of:
extending a first actuator mounted between a hub and a rotational member said rotational member and hub connected through a first pivotal joint; and
so rotating the rotational member about the first pivotal joint from a vertical position to a horizontal position.

17. The method according to claim 16, further including the steps, after the rotating step, of:
extending a second actuator mounted between the rotational member and a sleeve member, said sleeve member in sliding engagement with the rotational member; and
so extending the sleeve member.
